(19) United States
(12) Patent Application Publication
(10) Pub. No.: US 2018/0327096 A1
(43) Pub. Date: Nov. 15, 2018

(54) LUMINAIRE AND LUMINAIRE MODULE

(71) Applicant: DIEHL AEROSPACE GMBH, Ueberlingen (DE)

(72) Inventor: Bastian LINS, Erlangen (DE)

(73) Assignee: DIEHL AEROSPACE GMBH, Ueberlingen (DE)

(21) Appl. No.: 15/977,077

(22) Filed: May 11, 2018

(30) Foreign Application Priority Data
May 12, 2017 (DE) 102017004579.8

(51) Int. Cl. B64D 11/00; B60Q 3/47; B60Q 3/43; B60Q 3/44

(52) U.S. Cl. CPC B64D 11/00; B60Q 3/47; B64D 2011/0053; B60Q 3/44; B64D 2203/00; B60Q 3/43

(57) ABSTRACT

In the case of a luminaire for an interior of a vehicle, comprising a main body for securing to the vehicle, comprising at least one light source secured to the main body, at least one of the light sources is a matrix LED, wherein the matrix LED comprises at least two mutually independently drivable LED pixels, and the LED pixels are integrated on an LED chip.

A matrix LED is used as a light source in a luminaire.

A luminaire module, comprising at least one luminaire, wherein at least one of the luminaires is a luminaire according to the invention comprising a control input, and comprising a transducer connected to the control input, contains a control and evaluation unit for driving at least one of the matrix LEDs via the control input depending on the transducer.

### BACKGROUND OF THE INVENTION

The invention relates to a luminaire for an interior of a vehicle and to a luminaire module comprising a luminaire of this type.

### DISCUSSION OF THE PRIOR ART

Luminaires for an interior of a vehicle are known from the art for example in the form of LED luminaires for an aircraft cabin. In the luminaires, discrete LED components are installed on printed circuit boards. For systems having a full colour capability, systems comprising individual LEDs of different colours are used (for example respective RGBW LEDs, R: red G: green B: blue W: white).

### SUMMARY OF THE INVENTION

The present invention provides to specify an improved luminaire, for an interior of a vehicle.

The luminaire contains a main body. The main body serves for securing the main body and thus for securing the entire luminaire to the vehicle. The luminaire contains at least one light source. The light source is secured to the main body. At least one of the light sources is a matrix LED. The matrix LED comprises at least two LED pixels. The LED pixels are integrated in an LED chip. The pixels are mutually independently drivable, in particular mutually independently switchable on and off and possibly dimmable.

The invention is based on the observation that so-called matrix LEDs, which are also called “segmented LED on chip”, are currently being developed for use in automotive matrix headlights. The objective here is a dynamic adaptation of the driving light and/or main beam and the adaptive suppression of glare for the oncoming traffic. The matrix LEDs being developed in that context generate white light. The invention is also based on the insight that this principle should also be applicable to the production of coloured matrix LEDs. Matrix LEDs of this type are known for example from “‘3000 Pixel pro Autoscheinwerfer’ [‘3000 pixels per automobile headlight’], VDI-Nachrichten, No. 47, 25 Nov. 2016, page 19” or from “‘Bessere Sicht bei Nachtfahrten’ [‘Better visibility during night journeys’], Fraunhofer Forschung Kompakt, March 2016, page 1”.

The invention is based on the matrix LEDs described above or at least those which are similar to the ones described above and have individually drivable LED pixels in a 1D or 2D matrix, for example 32×32 LED pixels on a chip size of 4 mm×4 mm. According to the invention, such matrix LEDs or comparable technologies are contained in a luminaire for an interior of a vehicle, in particular of an aircraft cabin. A “comparable technology” would be, for example, a matrix LED having only one column or row, that is to say a “linear LED”, in which a large number of pixels, for example at least 16, 32, 64, 128 or 256 pixels, are integrated on an LED chip in a 1D line arrangement rather than in the manner of a 2D matrix.

A matrix LED within the meaning of the present invention is an integrated optoelectronic component. In the case of the latter, a multiplicity of LEDs are integrated on a chip. The individual LEDs are arranged in the form of a matrix and respectively form a pixel. In other words, a matrix LED is an integrated multi-pixel LED chip produced by microstructuring means. Integrating the LEDs on a chip greatly reduces the space requirement compared with a corresponding arrangement of single LEDs. A larger number of LEDs or pixels can thus be arranged for the same structural space. The individual LEDs or pixels are driven by suitable digital driver electronics, in a manner similar to that in the case of a display. Compared with an arrangement of individual LEDs that each necessitate a dedicated line for their driving, significantly fewer lines are necessary for driving the matrix LED situated on a chip.

The invention provides a luminaire whose light characteristic is adaptable in two spatial directions in the case of a 2D matrix LED or in one spatial direction in the case of a 1D line. This adaptation is effected by selective switching-on/switching-off/dimming of the individual pixels of the matrix LEDs used. This consideration usually applies to matrix LEDs that emit in one colour. For matrix LEDs comprising multicoloured emitters, luminaires having full colour capability can also be realized by colour mixing.

In this case, the adaptation of the light characteristic in two spatial directions means the characteristic not only of the emitted brightness but also of the colour of the generated light. Depending on the type of luminaire (spotlight, reading luminaire, linear luminaire, surface luminaire, . . . ) at least one up to many matrix LEDs can be installed in a luminaire.

According to the invention, the light characteristic both of linear luminaires and of spotlight/reading luminaires, etc. is adaptable by corresponding driving of the finished luminaire or of the matrix LEDs (different driving of individual pixels) without mechanical adjustment by means of the individual pixels being suitably driven individually or independently of one another. That can also mean that some pixels are never used.

According to the invention, an extension of the use and design possibilities of LED-based luminaires to the areas described results from the use of the matrix LED components. According to the invention, a luminaire comprising matrix LEDs thus results. The use of segmented “LED on chip” matrix LEDs in aircraft cabin luminaires allows a static or dynamic adaptation of the emission characteristic by corresponding driving of the individual pixels of the matrix LEDs. This generally applies to all luminaires for interiors of vehicles.

A further advantage of the invention is that energy is consumed only in the case of switched-on LED pixels. Compared with the masking-out or shading of already generated portions of light by mechanical measures or else compared with the use of projectors, an increased efficiency and the advantages associated therewith are achieved as a result.

In one preferred embodiment of the invention, at least one of the matrix LEDs is one which generates single-coloured light during operation. Alternatively or additionally, at least one of the matrix LEDs is one which generates light of variable colour during operation. In the first case, the matrix LED is thus one for emitting single-coloured light. This can be white but also arbitrarily coloured, for example red or green, light. The light colour is not variable, however, during operation.

Preferably, however, the light colour is variable. This is achieved for example by LED pixels of different primary colours, i.e. for generating differently coloured light. By way of example, R, G, B and W pixels are then present on an LED chip. Light of corresponding mixed colours arises as a result of different driving of the respective pixels, wherein both brightness and colour of the light are variable during operation.

In this regard, it is possible to provide either cost-effective luminaires (single-coloured light) or luminaires for particularly variable use (multicoloured or variable light with regard to colour and brightness).

In one preferred embodiment, the matrix LED has a characteristic dimension of at most 20 millimetres, preferably at most 15 millimetres, preferably at most 10 millimetres, preferably at most 6 millimetres, preferably at most 4 millimetres. Alternatively or additionally, the matrix LED comprises at least 4×4, preferably at least 8×8, preferably at least 16×16, preferably at least 32×32, LED pixels in a planar 2D arrangement. A characteristic dimension is, for example, a length, width, diameter or largest lateral extent of an LED chip, in each case relating to the active LED area, i.e. the area covered with LED pixels.

Matrix LEDs of this type are thus comparatively small compared with arrangements comprising conventional individual LEDs and comprise a multiplicity of LED pixels, for example 1024 pixels, which are arranged in particular as a 2D matrix. The individual or independent individual driving of the individual pixels makes it possible to realize light emission characteristics of the matrix LED that are manifested in a particularly large number of variants; in particular, it is possible for light to be emitted in specific spatial directions in a targeted manner, not to be emitted or to be emitted with desired brightness.

In one preferred embodiment, the luminaire is a linear luminaire which extends along a longitudinal axis and which contains at least two light sources, wherein at least two of the light sources are arranged alongside one another or in series in the direction of the longitudinal axis. In particular, all the light sources are arranged alongside one another or in series in the direction of the longitudinal axis. This gives rise to e.g. comparatively narrow linear luminaires of arbitrary length, the minimum width of which is substantially only determined by the width of the respective matrix LEDs. Linear luminaires of this type are suitable particularly for use in aircraft as vehicles and therein in the passenger cabin as interior. According to the invention, a linear luminaire comprising matrix LEDs thus results, in which a plurality of matrix LEDs are strung together in the longitudinal direction on a printed circuit board.

In an alternative embodiment, the luminaire is a spotlight or reading luminaire with one single or a few matrix LEDs incorporated therein.

In an alternative embodiment, the luminaire is a surface luminaire which contains at least three light sources, wherein at least three of the light sources are arranged alongside one another in a manner distributed two-dimensionally or in a manner distributed in a planar fashion. The light sources are thus distributed in a plane or area, that were not all strung together linearly. By way of example, in the case of three light sources, the latter are distributed in the form of a triangle. In the case of more light sources, the latter are distributed two-dimensionally for example in rows and columns. This gives rise to e.g. comparatively large-area luminaires having a high light emission power, such as e.g. washlights, or else small light-intensive luminaires such as, for example, spotlights, reading or table luminaires. Luminaires of this type, too, are suitable particularly for use in passenger cabins of aircraft. According to the invention, a surface luminaire thus results, in which a plurality of matrix LEDs are strung together in two directions on a printed circuit board.

In one preferred embodiment, the luminaire comprises a covering. The covering comprises a potential passage region for light that can be generated by at least one of the matrix LEDs. The covering is at least partly transparent in said passage region. Each matrix LED comprises a potentially largest emission region if all the LED pixels of the matrix LED are maximally active, i.e. emit light, in accordance with their regular operation. The emission region is “potential” because not necessarily all of the LED pixels need to be fully switched on during real operation. The actual emission region of the matrix LED can thus also be smaller. The largest possible potential emission region defines, by virtue of its area of intersection with the covering, the maximum potential passage region for light of the matrix LED. Since the corresponding passage region is at least partly transparent, all light potentially generated by the matrix LED can actually also leave the luminaire. In particular, the luminaire is completely transparent in the entire passage region, such that all potentially generated light of the matrix LED can also leave the luminaire or penetrate through the covering. In the case of such a luminaire, the full potential of the matrix LED can be utilized since all light that can be generated thereby can actually leave the luminaire.

In one preferred embodiment, the luminaire, in the entire potential emission region of light of at least one of the matrix LEDs has no element which variably modifies the light emitted by the matrix LED. In other words, a luminaire of this type has no variable beam shaping, brightness change or colour change for the light of the matrix LED. The corresponding change in the light conditions is realized solely by a variable driving of the matrix LED. In this regard, particularly simple and cost-effective luminaires arise in which characteristics of the emitted light (direction, brightness, colour, distribution, beam shape) are nevertheless variable.

In one preferred embodiment, the luminaire contains a configuration means. In the configuration means, a configuration for driving the LED pixels of at least one of the matrix LEDs is definable. The configuration is not variable in particular during regular operation of the luminaire. The configuration, once defined, is thus variable—if at all —only during service operation or during a service procedure. This necessitates for example an opening of the covering of the luminaire, the connection of a programming plug, the operation of a dip switch, etc. During regular operation in practice, the configuration is defined and not variable, that is to say in particular during a regular passenger flight of a passenger aircraft. In that case the reconfiguration is not possible, complicated, not provided in accordance with the requirements, at least unusual or possible only with aids. The definition of the driving in the form of the configuration is thus effected for example only during production of the luminaire, during the mounting thereof at the site of use, or during a reconfiguration in the context of service activity on the luminaire.

As a result, this therefore involves a “static” adaptation of the luminaire, in particular once or during service activity. Said adaptation serves in particular for calibrating the light characteristic of the luminaire. Calibration data are then stored in the configuration means. By way of example, differences between luminaires of the same type which arise as a result of manufacturing tolerances can be compensated for. Moreover the currently very stringent (and hence cost-intensive) requirements in respect of the manufacturing tolerances of the luminaire components can be relaxed since a corresponding calibration can also be carried out after manufacture. Calibration here relates for example to brightness, light distribution and colour of the light generated by the matrix LED. The static adaptation can also serve for adapting mechanically identical types of luminaire to different installation situations in which a similar but not identical, light characteristic is demanded. Configuration data are then stored in the configuration means. By way of example, the emission angle, the beam shape or the beam size can be changed. As a result, the mechanical design diversity can be reduced and new lighting requirements can be satisfied using already existing luminaires.

In one preferred embodiment, the luminaire comprises a control input, via which at least one of the LED pixels of one of the matrix LEDs is drivable (variably, individually, independently of other LED pixels) during regular operation. In contrast to the static adaptation above, a dynamic adaptation during regular operation, i.e. during operation for the final customer, is possible with a luminaire of this type. Such an adaptation via driving at the control input can be used for example as part of programmed or programmable light scenarios in the aircraft cabin, for example in order to use a different lighting distribution during boarding in comparison with that used during specific flight phases (take-off, landing, eating, sleeping, etc.). By way of example, boarding may be assumed to involve many standing passengers, such that a light distribution is driven which minimizes glare for standing passengers. By virtue of the control input, a transducer-based control of the luminaire is also possible. The luminous behaviour of the matrix LED is thus varied as a reaction to the data acquired by the transducer, e.g. a switch or sensor, e.g. ambient conditions (presence of persons, ambient light, temperature, position of rotary knob). By way of example, a dimming, i.e. reduction of brightness, is effected if persons pass through the light cone of the matrix LED, or a targeted illumination is effected only for currently used regions of a reading luminaire, etc.

In one preferred embodiment, the luminaire is a luminaire for an interior in the form of a passenger cabin and/or for a vehicle in the form of an aircraft.

The luminaire according to the invention is particularly suitable for use in passenger cabins or for aircraft.

The present invention is also directed to the use of a matrix LED as light source of a luminaire in accordance with the invention, such as has been described above. The use and at least some of the embodiments thereof and also the respective advantages have already been explained analogously in association with the luminaire according to the invention.

Still further, the present invention is directed to a luminaire module containing at least one luminaire. At least one of the luminaires is a luminaire according to the invention comprising the control input, such as has been described above. The luminaire module contains a transducer connected to the control input, and a control and evaluation unit. The latter serves for driving at least one of the matrix LEDs via the control input thereof depending on the transducers or a transducer signal present at the transducer. The transducer is e.g. a sensor or an input unit or an operating element for users. In this case, the control and evaluation unit can be situated within or outside the luminaire. The transducer signal is a signal which varies depending on the detection state of the transducer. Consequently, a luminaire module arises which generally can react to correspondingly varied transducer signals with varied light emission and is thus embodied adaptively with regard to the transducer. A luminaire module of this type can be used in a particularly flexible fashion.

The method and at least some of the components thereof and also the respective advantages have already been explained analogously in association with the luminaire according to the invention.

In one preferred embodiment, the transducer is an operating element. A deliberate or targeted driving of the luminaire module or of the luminaire with the matrix LED is thus possible. The transducer is for example part of a light control unit in an aircraft, which light control unit is operated by the cabin personnel during regular operation in order for example to set different light scenarios in the aircraft. A light control unit of this type is also referred to as “Attendant Control Panel” (ACP).

In particular, the transducer is an operating element that is regularly operable by a user of the luminaire in the form of a passenger. In particular, the beam shape or beam direction of the transducer can be varied by the transducer, for example. The transducer is then positioned for example in the direct area of action of the luminaire or of a passenger using the luminaire in the interior; in the case of an individual luminaire in an interior, for example, on a seat or interior region assigned to the luminaire. The luminaire is then a reading luminaire, washroom luminaire or a sleeping light, for example. The transducer can thus be a transducer which is available at a passenger's seat location and via which the passenger can individually set lighting at his/her location.

In one preferred embodiment, the transducer is a sensor, in particular a presence sensor, a brightness sensor, a motion sensor or the like. The transducer then encompasses an ambient condition, an event, a movement or other characteristics of objects or spaces in order to generate corresponding transducer signals. Via the control and evaluation unit, the light emission characteristic of the matrix LED or luminaire is then varied adaptively depending on the transducer signal. Adaptive luminaires or luminaire modules can thus be provided.

The invention is based on insights, observations and/or considerations below and also comprises the embodiments hereinafter. In this case, the embodiments in some instances are also called “the invention” for simplification. The embodiments here can also contain parts or combinations of the embodiments mentioned above or correspond thereto and/or, if appropriate, also include embodiments not mentioned hitherto.

The invention is based on the concept of providing luminaires for interior lighting, in particular aircraft cabin lighting, having a defined emission behaviour. In this case, it is necessary to satisfy, depending on predefinition, specific requirements with regard to the light characteristic. “Light characteristic” here means the spatial distribution of the emitted light first with regard to brightness (intensity) and secondly with regard to light colour. The invention is based on the insight that previous linear luminaires in the aircraft cabin are realized by linear juxtaposition of clusters of individual discrete LED components on a printed circuit board in the longitudinal direction. The juxtaposition of a plurality of LEDs in the transverse direction is not possible, or is possible only to a very limited extent, for space reasons. By way of example, four or five LEDs, for example, can be arranged in the transverse direction, but not ten or more, for example. An adaptation of the light characteristic of the finished luminaires by suitable driving of the LEDs is thus possible only in the longitudinal direction. Previous spotlight or reading luminaires are adaptable in their emission characteristic, if at all, by mechanical adjustment of the optical elements. Luminaires developed for different light distributions (emission characteristics) are always provided with different beam-shaping optical units (lenses or the like) since the characteristic of the source (discrete individual LEDs) is not variable. Luminaires, once they have been produced, are then no longer variable or calibratable in terms of their emission behaviour.

By virtue of the invention, by way of example, ceiling lighting is possible for various sealing configurations, in particular through embodiments as linear luminaires. The aircraft manufacturer often offers the airlines different ceiling configurations in the aircraft cabin. By way of example, in aircraft having two aisles there are variants with and without luggage compartments above the central seats. The lighting requirement for a luminaire that illuminates the ceiling from the edge of the cabin in the direction of the centre depends on whether a ceiling configuration with or without luggage compartments is installed in the centre. If luggage compartments are installed, the corresponding front surface of the compartments ought to be illuminated. If no luggage compartments are installed, given the same light distribution the passengers in the opposite lateral row of seats might possibly be dazzled, which should be avoided.

Instead of a mechanically adapted luminaire, with the aid of the invention described, for this situation the corresponding pixels of the matrix LEDs that would generate the undesired light can be dimmed and dazzle can be avoided. As a result, the same luminaire can be used in both situations and there is no need to develop an additional luminaire variant. The adaptation is effected statically during production or during construction of the luminaire.

By virtue of the invention, table lighting is also possible with the embodiments of spotlight or reading luminaire. In small private aircraft the customer can arrange the interior equipment in the cabin as desired. By way of example, the customer may choose a round or an angular table. Both tables are intended to be illuminated by a spotlight in such a way that the tabletop is illuminated, but no light shines past the table to the floor. By means of corresponding driving of the matrix LED in the spotlight, it is possible to fit the table contours in an accurately targeted manner, without a need to develop a dedicated luminaire for every table geometry. Under the assumption that the table additionally has a fold-out extension, the light cone could correspondingly be enlarged dynamically to the extended table region in a sensor-controlled manner (upon the table being folded out).

By virtue of the invention, reading luminaires are also possible in the embodiment as a surface luminaire. Reading luminaires are usually installed in the ceiling above the passenger seats. If there are three seats alongside one another in economy class, there may be only two seats, for example, in business class. It would thus be necessary to incorporate into the ceiling a solution comprising in one instance three and in one instance two individually usable reading luminaires. A change in the seating arrangement then means a corresponding adaptation of the reading luminaires. With a solution by means of the invention described, the reading luminaires can be realized by a single matrix LED luminaire module, for example as a surface luminaire embodiment. Depending on the occupancy or seating arrangement of the aircraft, the module is configured such that three or two regions can be driven individually with the suitable light distributions.

### BRIEF DESCRIPTION OF THE DRAWINGS

Further features, effects and advantages of the invention are evident from the following description of one preferred exemplary embodiment of the invention and the accompanying figures. In this case, in a schematic basic diagram:

FIG. 1 shows a spotlight/reading luminaire,

FIG. 2 shows a linear luminaire,

FIG. 3 shows a surface luminaire,

FIG. 4 shows a luminaire with covering and various beam configurations,

FIG. 5 shows a passenger cabin in two variants with differently configured luminaire,

FIG. 6 shows a luminaire module with two table variants.

### DETAILED DESCRIPTION OF THE INVENTION

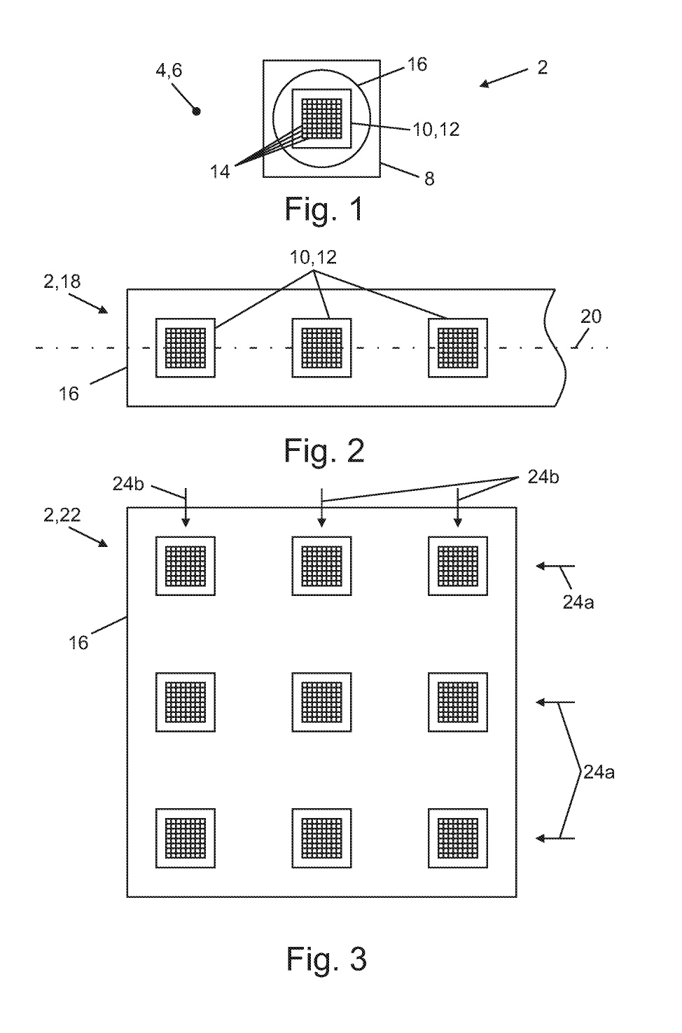

FIG. 1 shows a luminaire 2 for an interior 4 (not illustrated in more specific detail in FIG. 1) of a vehicle 6 in plan view. The luminaire 2 contains a main body 8, by means of which the luminaire 2 is secured in the interior 4 or to the vehicle 6. The luminaire 2 also contains a light source 10 in the form of a matrix LED 12, which is secured to the main body 8. The matrix LED 12 comprises 8×8, that is to say 64, LED pixels 14 in the example. In this case, the matrix LED 12 is mounted on a printed circuit board 16. The luminaire 2 is a spotlight or a reading luminaire.

FIG. 2 shows an excerpt from a different luminaire 2 in the form of a linear luminaire 18 extending along a longitudinal axis 20. The main body 8 is omitted for the sake of clarity. In the example, the linear luminaire contains a plurality of light sources 10, three of which are illustrated. All the light sources 10 are arranged alongside one another or in series along or on the longitudinal axis 20.

FIG. 3 shows a different luminaire 2 in the form of a surface luminaire 22. The main body 8 is omitted again for the sake of clarity. In the example, the surface luminaire 22 contains nine light sources 10 in the form of matrix LEDs 12, which are arranged alongside one another in a manner distributed two-dimensionally, specifically are arranged here in rows 24a and columns 24b.

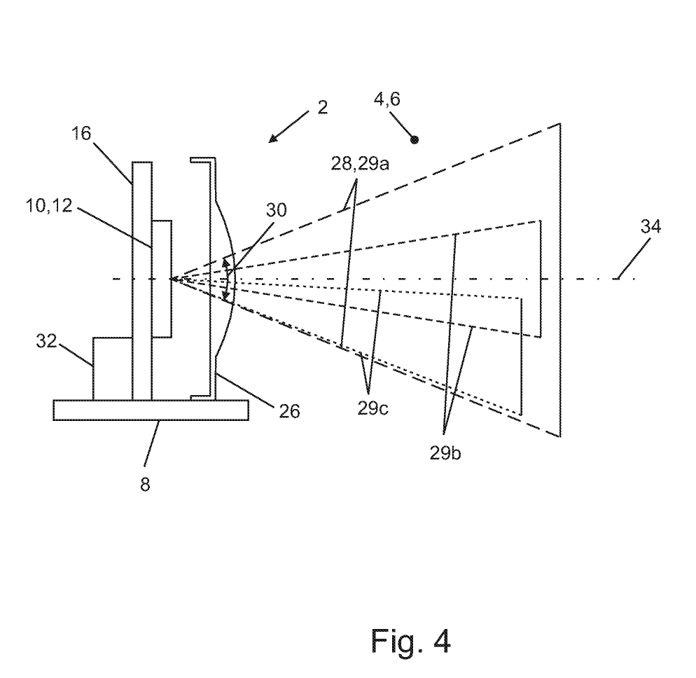

FIG. 4 shows an alternative luminaire 2 comprising main body 8 and light source 10 as matrix LED 12 in side view. The luminaire 2 additionally comprises a covering 26. In full operation, that is to say when all the LED pixels 14 emit light as intended, the matrix LED 12 generates a luminous cone or emission region 28 of maximum size. The intersection between the maximum emission region 28 and the covering 26 forms a potential passage region 30 of maximum size for light that is generated by the matrix LED 12 and impinges on the covering 26. In the entire passage region 30, therefore, the covering is at least partly transparent, here completely transparent.

Although in the passage region 30 the covering 26 forms a beam-shaping element, here a lens in the beam path or emission region 28 of the light of the matrix LED 12. The beam shaping is not variable, but rather fixed.

The luminaire 2 contains a configuration means 32, a memory chip in the example, which is indeed variable with regard to its configuration and/or programming e.g. during service work on the luminaire 2, but is not variable in this regard during regular operation of the luminaire 2. The configuration defines which of the LED pixels 14 of the matrix LED 12 are driven and how. Different beam profiles or light cones 29a-c arise depending on the configuration, wherein the light cone 29a in the case of a first configuration (driving of all the LED pixels 14) generates the largest beam profile corresponding to the emission region 28. The light cone 29b is generated on the basis of a second configuration and forms a narrower, but centred beam profile with respect to a central optical axis 34; the light cone 29c in accordance with a third configuration is an asymmetrical beam profile with respect to the central optical axis 34. In the example, the matrix LED 12 is one for generating coloured light. Through configuration the light cone 29a is one for white light, the light cone 29b is one for blue light and the light cone 29c is one for violet light (mixture of R and B portions from R and B LED pixels 14). The emitted light colour of the luminaire 2 is thus also configured correspondingly in the configuration means 32.

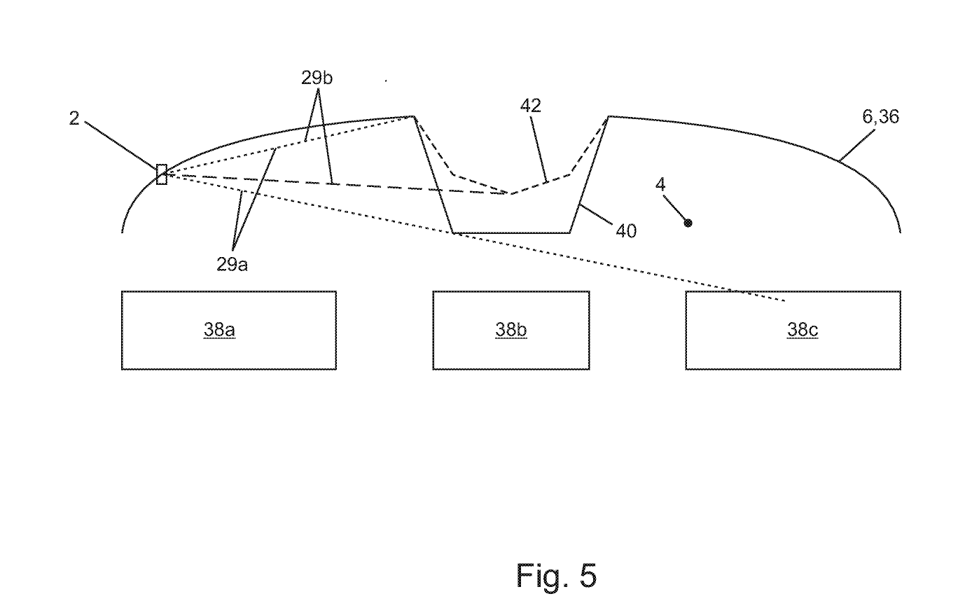

FIG. 5 symbolically shows a further example of two different configurations of a luminaire 2 by a configuration means 32. Of the vehicle 6, here an aircraft, part of the interior 4, here of a passenger cabin, is shown, specifically a ceiling region 36 and also a left 38a, central 38b and right 38c row of seats. In a first variant or fitting-out variant of the aircraft 6, the ceiling region 36 has central luggage compartments 40 above the row 38b of seats. In a first configuration, the luminaire 2 generates light having the light cone 29a in order to illuminate the side wall of the luggage compartments 40.

From the manufacturer of the aircraft 6, the latter can also be procured in a different configuration, specifically without the luggage compartments 40, but rather with an alternative ceiling section 42. If the luminaire 2 here were likewise operated with the configuration with light cone 29a, passengers in the right row 38c of seats may be dazzled by the luminaire 2, as is indicated by a dashed line. Therefore, using the same luminaire 2, the latter is merely reconfigured with regard to its configuration means 32 during the production of the aircraft 6 in order that it operates with the light cone 29b. Only the structure element 42 is now illuminated. A dazzle effect in the row 38c of seats is now avoided.

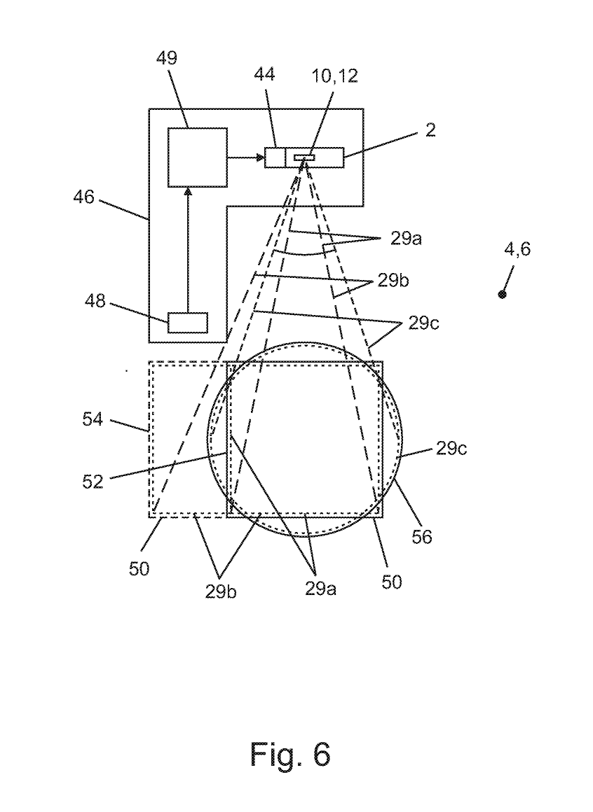

FIG. 6 shows symbolically for an alternative aircraft as vehicle 6 a luminaire 2 comprising a control input 44, via which at least one, here all, of the LED pixels 14 of the matrix LED 12 are drivable during regular operation. The luminaire 2 is part of a luminaire module 46, which also contains a transducer 48 besides the luminaire 2 having the control input 44. The transducer 48 here is a sensor for detecting a folding position of a folding table 50. The transducer is connected to the control input 44 via a control and evaluation unit 49.

If the folding table 50 is in a folded-in position, then it has the area of a square tabletop 52 that is to be illuminated by the luminaire 2. The folded-in position is identified by the transducer 48 and the luminaire 2 is driven with a light cone 29a that illuminates the square tabletop 52 with register accuracy. If the folding table 50 is folded out and the tabletop 52 is thus extended rectangularly by an additional element 54, this is likewise identified by the transducer 48. Via the control and evaluation unit 49, the control input 44 is driven such that the light cone 29b results, which rectangularly illuminates the tabletop 52 together with the additional element 54 with register accuracy.

From the manufacturer the aircraft or vehicle 6 is available once again in an alternative configuration with a round table 56. The same luminaire 2 is installed in this aircraft, too. However, the control and evaluation unit 49 now drives the luminaire 2 in such a way that a round light cone 29c results, which now illuminates the round table 56 with register accuracy. The transducer 48 is now an input means that is operable by a user of the round table 56 in order to vary as desired the colour and brightness of the light generated by the luminaire 2.

### LIST OF REFERENCE SIGNS

2 Luminaire
4 Interior
6 Vehicle
8 Main body
10 Light source
12 Matrix LED
14 LED pixel
16 Printed circuit board
18 Linear luminaire
20 Longitudinal axis
22 Surface luminaire
24a Row
24b Column
26 Covering
28 Emission region
29a-c Light cone
30 Passage region
32 Configuration means
34 Optical axis
36 Ceiling region
38a-c Row of seats
40 Luggage compartments
42 Ceiling section
44 Control input
46 Luminaire module
48 Transducer
49 Control and evaluation unit
50 Folding table
52 Tabletop
54 Additional element
56 Round table

What is claimed is:

1. A luminaire for an interior of a vehicle, comprising a main body for securing to the vehicle, comprising at least one light source secured to the main body, wherein
at least one of the light sources is a matrix LED, wherein the matrix LED comprises at least two mutually independently drivable LED pixels, wherein the LED pixels are integrated on an LED chip.

2. The luminaire according to claim 1, wherein at least one of the matrix LEDs is a matrix LED which generates single-coloured light during operation, and/or at least one of the matrix LEDs is a matrix LED which generates light of variable colour during operation.

3. The luminaire according to claim 1, wherein the matrix LED has a characteristic dimension of at most 20 mm, and/or comprises at least 4×4 LED pixels.

4. The luminaire according to claim 3, wherein the matrix LED has a characteristic dimension of at most 15 mm.

5. The luminaire according to claim 4, wherein the matrix LED has a characteristic dimension of at most 10 mm.

6. The luminaire according to claim 5, wherein the matrix LED has a characteristic dimension of at most 6 mm.

7. The luminaire according to claim 6, wherein the matrix LED has a characteristic dimension of at most 4 mm.

8. The luminaire according to claim 3, wherein the matrix LED comprises at least 8×8 LED pixels.

9. The luminaire according to claim 8, wherein the matrix LED comprises at least 16×16 LED pixels.

10. The luminaire according to claim 9, wherein the matrix LED comprises at least 32×32 LED pixels.

11. The luminaire according to claim 1, wherein the luminaire is a linear luminaire which extends along a longitudinal axis and which contains at least two light sources, wherein at least two of the light sources are arranged alongside one another in the direction of the longitudinal axis.

12. The luminaire according to claim 1, wherein the luminaire is a surface luminaire which contains at least three light sources, wherein at least three of the light sources are arranged alongside one another in a manner distributed two-dimensionally.

13. The luminaire according to claim 1, wherein the luminaire contains a covering, which comprises a potential passage region for light of at least one of the matrix LEDs and which is at least partly transparent in said passage region.

14. The luminaire according to claim 1, wherein the luminaire, in the entire potential emission region of at least one of the matrix LEDs has no element which variably modifies the light emitted by said at least one matrix LED.

15. The luminaire according to claim 1, wherein the luminaire contains a configuration means, in which a configuration for driving the LED pixels of at least one of the matrix LEDs is definable.

16. The luminaire according to claim 1, wherein the luminaire comprises a control input, via which at least one of the LED pixels of one of the matrix LEDs is drivable during regular operation.

17. The luminaire according to claim 1, wherein the luminaire is a luminaire for an interior in the form of a passenger cabin and/or for a vehicle in the form of an aircraft.

18. A luminaire module, comprising at least one luminaire, wherein at least one of the luminaires is a luminaire according to claim 16, and comprising a transducer connected to the control input, and comprising a control and evaluation unit for driving at least one of the matrix LEDs via the control input depending on the transducer.

19. A luminaire module, comprising at least one luminaire, wherein at least one of the luminaires is a luminaire according to claim 17, and comprising a transducer connected to the control input, and comprising a control and evaluation unit for driving at least one of the matrix LEDs via the control input depending on the transducer.

20. The luminaire module according to claim 18, wherein the transducer is an operating element.

21. The luminaire module according to claim 20, wherein the transducer is an operating element that is operable by a user of the luminaire.

22. The luminaire module according to claim 18, wherein the transducer is a sensor.
